(19) United States
(12) Patent Application Publication
(10) Pub. No.: US 2024/0106628 A1
(43) Pub. Date: Mar. 28, 2024

(54) EFFICIENT SIDE CHANNEL PROTECTION FOR LIGHTWEIGHT AUTHENTICATED ENCRYPTION

(71) Applicant: Intel Corporation, Santa Clara, CA (US)

(72) Inventor: Santosh Ghosh, Hillsboro, OR (US)

(73) Assignee: Intel Corporation, Santa Clara, CA (US)

(21) Appl. No.: 17/935,973

(22) Filed: Sep. 28, 2022

(51) Int. Cl. H04L 9/06

(52) U.S. Cl. CPC H04L 9/0631

(57) ABSTRACT

A system and method for generating, from a permutation of a first input state, a first output state, a first rate and a first capacity, the first rate including a first portion of the first output state and the first capacity including a second portion of the first output state; storing the first output state; generating a first block of ciphertext data of a first packet from XORing the first rate and a first block of plaintext data of the first packet; generating a permutation of a value of the first block of ciphertext data of the first packet concatenated with the first capacity, and generating a second block of ciphertext data of the first packet from XOR of the permutation of the value of the first block of ciphertext data of the first packet concatenated with the first capacity.

### BACKGROUND

Authenticated Encryption (AE) is widely used to provide data confidentiality and integrity protection. Advanced Encryption Standard—Galois Counter Mode (AES-GCM) is one commonly used technique which is very compute intensive. Efforts are underway to develop more efficient lightweight cryptography (LWC) AE techniques. To achieve secure communication, protocols such as Transport Layer Security (TLS) and Media Access Control (MAC) security (MACSec) need side channel protection during data encryption and decryption. In TLS and MACSec, a session key is established, which is then used to encrypt multiple packets with different nonces. In many existing LWC AE implementations, the nonce is mixed with the session key and diffused to the entire state through permutation operations. An attacker can inject multiple packets with different nonces to the receiver and measure the side channel information for each execution of the nonce/session key combinations and mount a differential power analysis (DPA) or correlation power analysis (CPA) style attack. Traditional side channel protection techniques, such as masking of the underlying permutation, result in two to six times more circuit area/latency overhead. An AE solution that is lightweight (e.g., minimizes circuit area/latency overhead) but protects against side channel attacks is needed.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a block diagram of two computing systems according to one or more embodiments.

FIGS. 2A and 2B are block diagrams of an encryption circuit to process a first packet according to one or more embodiments.

FIGS. 3A and 3B are block diagrams of an encryption circuit to process a next packet according to one or more embodiments.

FIG. 4 is a flow diagram illustrating encryption processing according to one or more embodiments.

FIG. 5 is a schematic diagram of an illustrative electronic computing device to perform cryptographic processing according to some embodiments.

### DETAILED DESCRIPTION

The technology described herein provides encryption and decryption circuitry that mixes nonces with permutation output states to achieve side channel security with no logic area/latency overhead and minimal storage overhead (for example, as few as only one entire state).

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

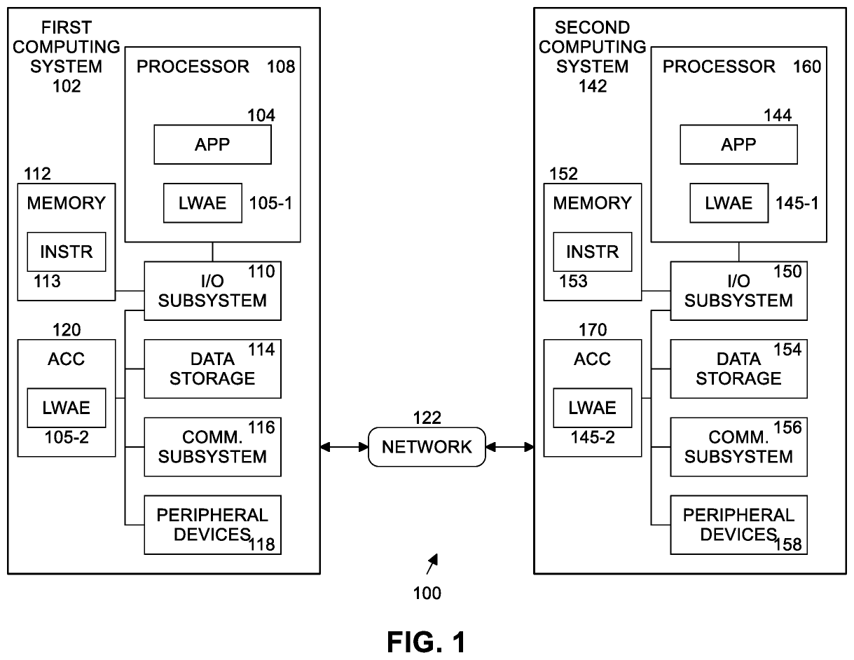

Referring now to FIG. 1, an illustrative computing environment 100 for secure communication of message encrypted with a shared secret includes first computing system 102 and second computing system 142 coupled over network 122. In one embodiment, for cryptographic purposes, one or more components of first computing system 102 is also called Alice herein, and one or more components of second computing system 142 is also called Bob herein. In another embodiment, one or more components of first computing system 102 is called Bob and one or more components of second computing system 142 is called Alice. First computing system 102 includes processor 108 to execute instructions (Instr) 113 stored in memory 112. Instructions 113 comprise at least one application 104 (App). Application 104 comprises any application program having at least one workload to be processed. In some processing scenarios, application 104 offloads one or more operations, including cryptographic operations (e.g., key generation, key encapsulation, key decapsulation, encryption, and decryption), to accelerator 120 (Acc) to be performed more efficiently than performing the one or more operations on processor 108.

Second computing system 142 includes processor 160 to execute instructions (Instr) 153 stored in memory 152. Instructions 153 comprise at least one application 144. Application 144 also comprises any application program having at least one workload to be processed. In some processing scenarios, application 144 offloads one or more operations, including cryptographic operations, to accelerator 170 (Acc) to be performed more efficiently than performing the one or more operations on processor 160.

Applications 104 and 144 communicate with each other in a secure manner using known cryptographic methods and operations. That is, application 104 may encrypt information to securely send the information to application 144 over unsecured network 122, which decrypts the encrypted information, and vice versa. In some implementations, the information to be securely sent over the network comprises one or more messages formatted into one or more packets, with each packet including one or more blocks of information.

In an embodiment, applications 104, 144 are the same application. In another embodiment, applications 104, 144 are different applications. In at least one embodiment, one or both of accelerator 120 and 170 is implemented as a field programmable gate array (FPGA).

In various computing environments, there may be any number of processors 108 and accelerators 120 on first computing system 102, any number of processors 160 and accelerators 170 on second computing system 142, and any number of first computing systems coupled to any number of second computing systems. In some large-scale cloud computing environments, the number of applications 104 and 144, first computing systems 102, second computing systems 142, and associated accelerators 120, 170 may be large (e.g., tens of systems, hundreds of systems, thousands of systems, tens of thousands of systems, thousands or millions of system components, etc.).

First computing system 102 and second computing system 142 can be embodied as any type of device capable of performing the functions described herein. For example, computing systems 102, 142 can be implemented as, without limitation, a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a disaggregated server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

As shown in FIG. 1, the illustrative computing systems 102, 142 include processors 108, 160, input/output (I/O) subsystems 110, 150, memories 112, 152, and data storage devices 114, 154, respectively. Additionally, in some embodiments, one or more of the illustrative components can be incorporated in, or otherwise form a portion of, another component. For example, memories 112, 152, or portions thereof, can be incorporated in processors 108, 160, respectively, in some embodiments.

Processors 108, 160 can be implemented as any type of processor capable of performing the functions described herein. For example, processors 108, 160 can be embodied as a single or multi-core processor(s), digital signal processor, microcontroller, or other processor or processing/controlling circuit.

Memories 112, 152 can be implemented as any type of volatile or non-volatile memory or data storage capable of performing the functions described herein. In operation, the memories 112, 152 store various data and software used during operation of computing systems 102, 142 such as operating systems, applications, programs, libraries, and drivers. In an implementation, memories 112, 152 may store plaintext data and/or ciphertext data and/or permutation output states. As shown, memories 112, 152 are communicatively coupled to the processors 108, 160 via I/O subsystems 110, 150 which are implemented as circuitry and/or components to facilitate input/output operations with processors 108, 160, memories 112, 152, and other components of the computing systems, respectively. For example, the I/O subsystems 110, 150 can be implemented as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations. In some embodiments, memories 112, 152 are directly coupled to processors 108, 160, respectively, for example via an integrated memory controller hub. Additionally, in some embodiments, I/O subsystems 110, 150 form a portion of a system-on-a-chip (SoC) and are incorporated, along with processors 108, 160, memories 112, 152 accelerators 120, 170, respectively, and/or other components of the computing systems, on a single integrated circuit chip. Additionally or alternatively, in some embodiments processors 108, 160 include an integrated memory controller and a system agent, which may be embodied as a logic block in which data traffic from processor cores and I/O devices converges before being sent to memories 112, 152.

Data storage devices 114, 154 can be implemented as any type of device or devices configured for short-term or long-term storage of data such as, for example, memory devices and circuits, memory cards, hard disk drives, solid-state drives, non-volatile flash memory, or other data storage devices. In an implementation, data storage devices 114, 154 may store plaintext data and/or ciphertext data and/or permutation output states. Computing systems 102, 142 can also include communications subsystems 116, 156 which can be implemented as any communication circuit, device, or collection thereof, capable of enabling communications between computing systems 102, 142 over a network 122. Communications subsystems 116, 156 can be configured to use any one or more communication technology (e.g., wired or wireless communications) and associated protocols (e.g., Ethernet, Bluetooth®, WiMAX, 3G, 4G LTE, etc.) to implement such communication.

Accelerators 120, 170 can be implemented as a FPGA, an application-specific integrated circuit (ASIC), a coprocessor, or other digital logic device capable of performing accelerated functions (e.g., accelerated application functions, accelerated network functions, or other accelerated functions), including accelerated cryptographic functions. Illustratively, accelerators 120, 170 are FPGAs, which are implemented as an integrated circuit including programmable digital logic resources that may be configured after manufacture. The FPGAs include, for example, a configurable array of logic blocks in communication over a configurable data interchange. Accelerators 120, 170 are coupled to the processors 108, 160 via high-speed connection interfaces such as peripheral buses (e.g., peripheral component interconnect (PCI) Express buses) or inter-processor interconnects (e.g., in-die interconnects (IDIs) or QuickPath Interconnects (QPIs)), or via any other appropriate interconnects. Accelerators 120, 170 receive data and/or commands for processing from the processors and return results data to the processors.

Computing systems 102, 142 further include one or more peripheral devices 118, 158. Peripheral devices 118, 158 include any number of additional input/output devices, interface devices, hardware accelerators, and/or other peripheral devices. For example, in some embodiments, peripheral devices 118, 158 include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices.

It is to be appreciated that lesser or more equipped computing systems than the examples described above may be preferred for certain implementations. Therefore, the configuration of computing systems 102, 142 can vary from implementation to implementation depending upon numerous factors, such as price constraints, performance requirements, technological improvements, or other circumstances.

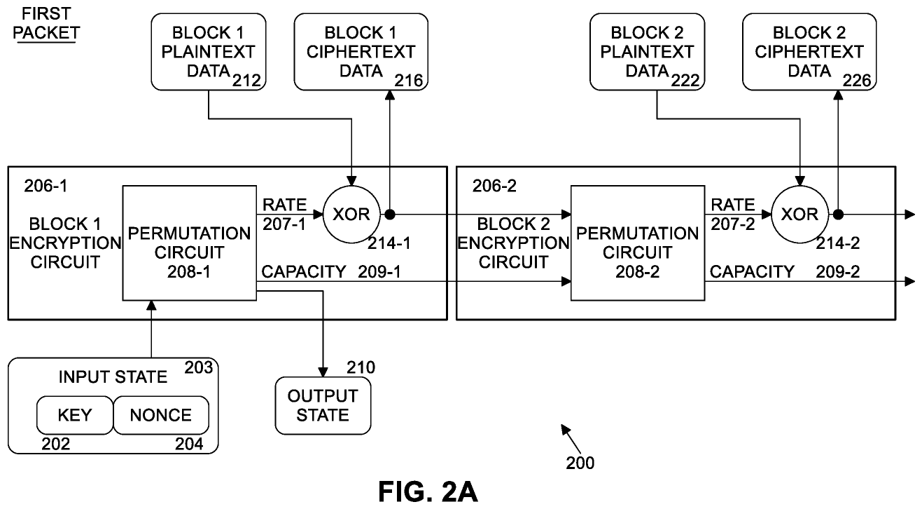

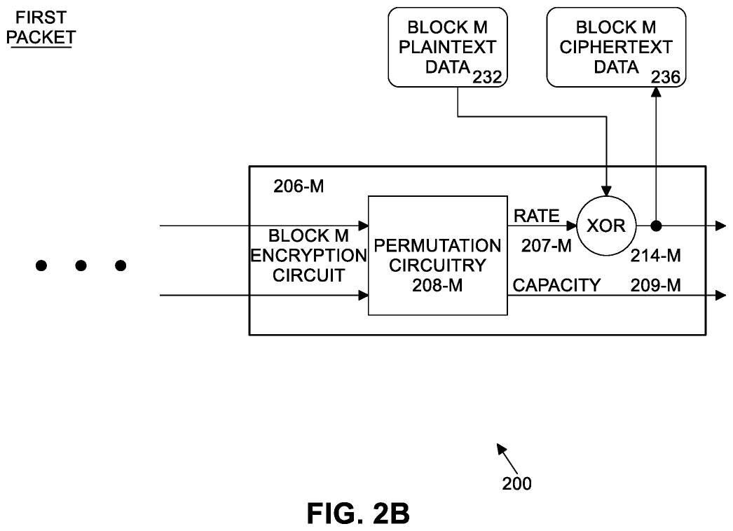

In an implementation, processor 108 of first computing system 102 includes circuitry for lightweight authenticated encryption (LWAE) 105-1 and/or decryption that provides efficient side channel protection as described in FIGS. 2 through 4. In another implementation, LWAE circuitry 105-2 may be included in accelerator 120. Similarly, processor 160 of second computing system 142 includes LWAE circuitry 145-1. In another implementation, LWAE circuitry 145-2 may be included in accelerator 170. First computing system 102 may include separate LWAE circuitry for encryption and LWAE circuitry for decryption. Similarly, second computing system 142 may include separate LWAE circuitry for encryption and LWAE circuitry for decryption. In an implementation, the LWAE circuitry may perform both encryption and decryption processing. In an implementation, the functionality of LWAE circuitry described herein may be performed by instructions executed by processor 108 and/or processor 160.

In one scenario, first computing system 102 encrypts one or more messages including one or more packets using one or more of LWAE 105-1 and LWAE 105-2, with each packet including one or more blocks, and sends the encrypted packets to second computing system 142. Thus, a plaintext message to be encrypted and sent from Alice to Bob may include one or more packets including ciphertext data, with each packet including one or more blocks. Second computing system 142 decrypts the ciphertext data in the received encrypted packets using one or more of LWAE 145-1 and LWAE 145-2 to reassemble the plaintext message. In another scenario, second computing system 142 encrypts one or more packets using one or more of LWAE 145-1 and LWAE 145-2, with each packet including one or more blocks, and sends the encrypted packets to first computing system 102. First computing system 102 decrypts the received encrypted packets using one or more of LWAE 105-1 and LWAE 105-2 to reassemble the plaintext message. Thus, any communication of messages between Alice and Bob may be bi-directional.

In many existing LWC AE schemes, the nonce is mixed (e.g., concatenated) with the secret session key and diffused to the entire state of the LWC AE processing through underlying permutation operations. For each new data encryption with the same secret session key, these schemes generate a new nonce. These nonces must be in sync between the two parties (e.g., Alice and Bob). One way this is typically done is by the sender (for example, Alice) generating the nonces randomly and send the nonces to the receiver (for example, Bob). Another way is by implementing a synchronized counter between the sender and the receiver. However, in both known ways, multiple nonces are mixed with the same secret session key. Therefore, an attacker can measure the side channel information for each execution of the nonce mixings and attempt a DPA/CPA style attack to recover the key. The existing nonce mixing schemes are the weakest point for a side channel attack on existing LWC AE computing systems.

Embodiments herein provide a way to handle nonces such that an attacker is deterred from multi-trace attacks during nonce mixing operations. Embodiments provide inherent side channel protection without any additional circuit area or latency overhead compared to existing techniques (e.g., masking has two to six times the overhead). Embodiments may be applicable to communication of packets of information in lossless channels between a sender and a receiver and to storage encryption applications.

LWAE circuitry 105-1, 105-2, 145-1, and/or 145-2 of FIG. 1 may be implemented as shown in FIGS. 2 through 4. In an implementation, processing of a first packet of a message is performed with different inputs than processing of a next packet of the message (and all subsequent packets of the message (including a last packet of the message)). FIGS. 2A and 2B are block diagrams of an encryption circuit 200 to process a first packet according to one or more embodiments. LWAE circuitry as shown in FIGS. 2A and 2B includes a plurality of block encryption circuits, denoted herein as block 1 encryption circuit 206-1, block 2 encryption circuit 2 206-2, . . . block M encryption circuit 206-M, where M is a natural number and M is the number of blocks in a packet of a message. In an implementation, the number of blocks M may be predetermined during the design of the LWAE circuitry.

Block 1 encryption circuit 206-1 includes permutation circuit 208-1. In an implementation, permutation circuit 208-1 implements an AE process as described in “Xoodyak, a lightweight cryptographic scheme” by Joan Daemen, et al., International Association for Cryptographic Research (IACR) Transactions on Symmetric Cryptography, Vol. 2020, No. 51, pp. 66-87, Jun. 22, 2020. In another implementation, permutation circuit 208-1 implements an AE process as described in “Ascon” by Christoph Dobraunig, et al., submission to the National Institute of Standards and Technology (NIST), Sep. 27, 2019. In a further implementation, permutation circuit 208-1 implements any suitable AE process. Input state 203 is input to Block 1 encryption circuit 206-1. For the first packet, input state 203 includes a concatenation of a key 202 (such as a secret session key) and an initial nonce 204. In an implementation, nonce 204 is randomly generated. In an implementation, the size of key 202 is 256 bits and the size of nonce 204 is 128 bits, and thus the size of input state 203 is 384 bits. In other implementations, other numbers of bits may be used for the sizes of key 202, nonce 204 and input state 203.

Operation of permutation circuit 208-1 encrypts input state 203 to generate output state 210 using a cryptographic permutation function of an AE process (e.g., Xoodyak, Ascon, or other suitable AE process). In an implementation, the size of output state 210 is 384 bits. In other implementations, other numbers of bits may be used for the size of output state 210. In an implementation, output state 210 comprises the lower 256 bits of the output of the permutation circuit. Output state 210 is stored for use in processing the next packet of the message. Output state 210 may be stored in any suitable memory or storage location (e.g., a register in processor 108 or processor 160A, a register in accelerator 120 or accelerator 170, data storage 114 or 154, etc.). In an implementation, one output state may be generated during processing of each packet.

A first portion of output state 210 may be used as rate 207-1 to be input to exclusive-OR (XOR) operation 214-1. In an implementation, the size of rate 207-1 is 128 bits. A second portion of output state 210 may be used as capacity 209-1. In an implementation, the size of capacity 209-1 is 256 bits. In an implementation, the bits of output state 210 comprising rate 207-1 and capacity 209-1 are mutually exclusive. In other implementations, the bits of output state 210 comprising rate 207-1 and capacity 209-1 are not mutually exclusive. The first block of the first packet of the plaintext message, called block 1 plaintext data 212, and rate 207-1 are input to XOR 214-1. XOR 214-1 combines block 1 plaintext data 212 with rate 207-1 to generate the first block of the first packet of the ciphertext message, called block 1 ciphertext data 216. In an implementation, the size of a block of plaintext data is 128 bits and the size of the block of ciphertext data is 128 bits. In another implementation, the size of a block of plaintext data, the size of a block of ciphertext data, and the size of the rate are not 128 bits but are the same size. Block 1 ciphertext data 216 may be stored in any memory or storage location for future communication to a receiver (e.g., Bob). Block 1 ciphertext data 216 and capacity 209-1 are input to processing of the next block, in this case block 2 encryption circuit 206-2.

Block 2 encryption circuit 206-2 is structured the same as and operates in a similar manner to block 1 encryption circuit 1 206-1. Block 2 encryption circuit 206-2 takes the next block of the first packet, block 2 plaintext data 222, as input and generates block 2 ciphertext data 226 using a concatenation of the next block of ciphertext data, block 2 of ciphertext data 226, concatenated with capacity 209-1 (output from the previous permutation done by permutation circuit 208-1 in block 1 encryption circuit 206-1). Block 2 encryption circuit 206-2 outputs block 2 ciphertext data 226 and capacity 209-2 for processing by a next block encryption circuit. Block encryption circuits may be duplicated M times, with a block encryption circuit to process each block of the first packet. Thus, Block M encryption circuit 206-M, shown in FIG. 2B, is structured the same as and operates in a similar manner to block 2 encryption circuit 1 206-2. Block M encryption circuit 206-M takes block M-1 plaintext data as input and generates block M ciphertext data 236. In an implementation, capacity 209-M may be discarded.

In an implementation, a single block encryption circuit may be used for all M blocks in a sequential, iterative manner, changing the input block of plaintext data and producing a different output block of ciphertext data and capacity in each iteration of the M iterations of operating the block encryption circuit to process a packet. The output block of ciphertext data and capacity from one iteration of the block encryption circuit are input to a next iteration of operation of the block encryption circuit. An implementation of a single block encryption circuit in this way minimizes the circuit area needed for the LWAE circuit.

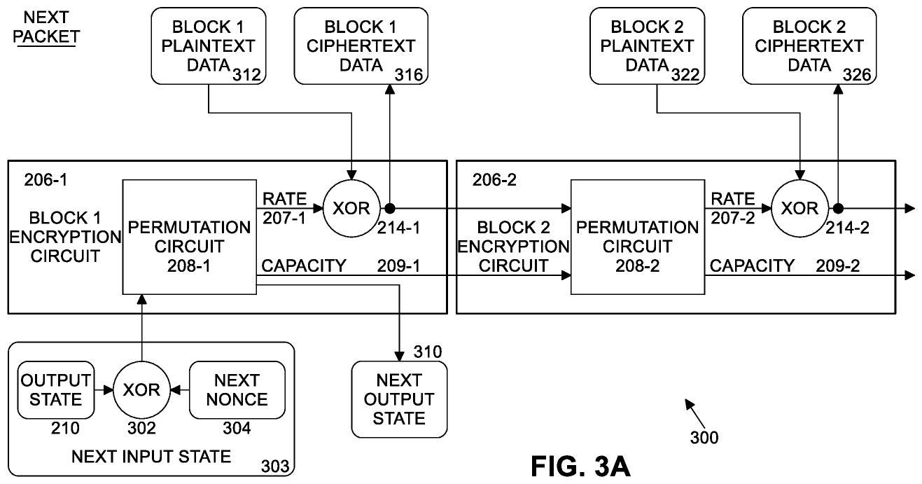

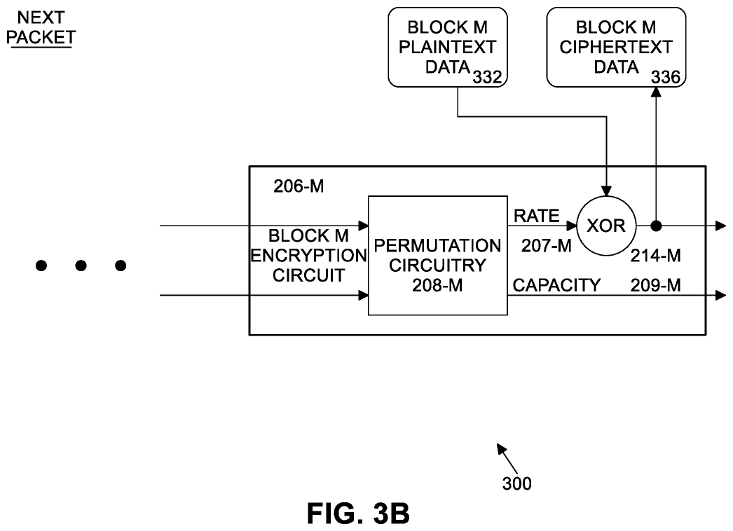

FIGS. 3A and 3B are block diagrams of an encryption circuit 300 to process a next packet according to one or more embodiments. For the next packet after the first packet, and all subsequent packets of the message (including a last packet of the message), next input state 303 is input to block 1 encryption circuit 206-1. In an implementation, next input state 303 includes output state 210 (from the processing of the first packet as shown in FIGS. 2A and 2B) XORed by XOR 302 circuit with a next nonce 304. In an implementation, next nonce 304 is a randomly generated data value used for processing the next packet. Thus, any nonce is used for encrypting only one packet, thereby helping to deter side channel attacks. The “next” nonces must be in sync between the two parties (e.g., Alice and Bob). Permutation circuit 208-1 generates next output state 310, which will be used as input to the next input state for processing the packet after the next packet.

In an implementation, when output state 210 comprises the lower 256 bits of the output of the permutation circuit for processing the first packet, these 256 bits of output state may be concatenated with next nonce 304 (instead of XORed by XOR 302) to form next input state 303.

Block encryption circuits 206-1, 206-2, . . . 206-M, perform processing as described above in FIGS. 2A and 2B for the first packet, except the input blocks of plaintext data are from the next packet of the message. The block encryption circuits output the ciphertext blocks of the next packet of the message.

The processing shown in FIGS. 3A and 3B are also performed for all subsequent packets in the message (including a last packet). Processing of all blocks of plaintext data of all packets of the message results in generation of all blocks of ciphertext data of all packets of the message. In an implementation, when generation of a packet of blocks of ciphertext data by Alice is complete, the packet of blocks of ciphertext data may be sent to Bob (or vice versa).

FIGS. 2A and 2B, and 3A and 3B describe encryption processing to be performed by a sender (e.g., Alice) of the plaintext message. The receiver (e.g., Bob) of the ciphertext message may decrypt the ciphertext message by exchanging the use of the blocks of plaintext data and blocks of ciphertext data by the block encryption circuits. Thus, for decryption processing, the blocks of ciphertext data (e.g., block 1 ciphertext data 216) are input to the XOR circuits (e.g., XOR 214-1) and the XOR circuits generate the blocks of plaintext data (e.g., block 1 plaintext data 212). This assumes that the receiver (e.g., Bob) has the key 202 and nonce 204 in order to generate the needed input state 203.

In an implementation, only one output state of each packet is stored. In another implementation, output states for all packets of a message may be stored to assist in efficient recreation of the encrypted message, if needed.

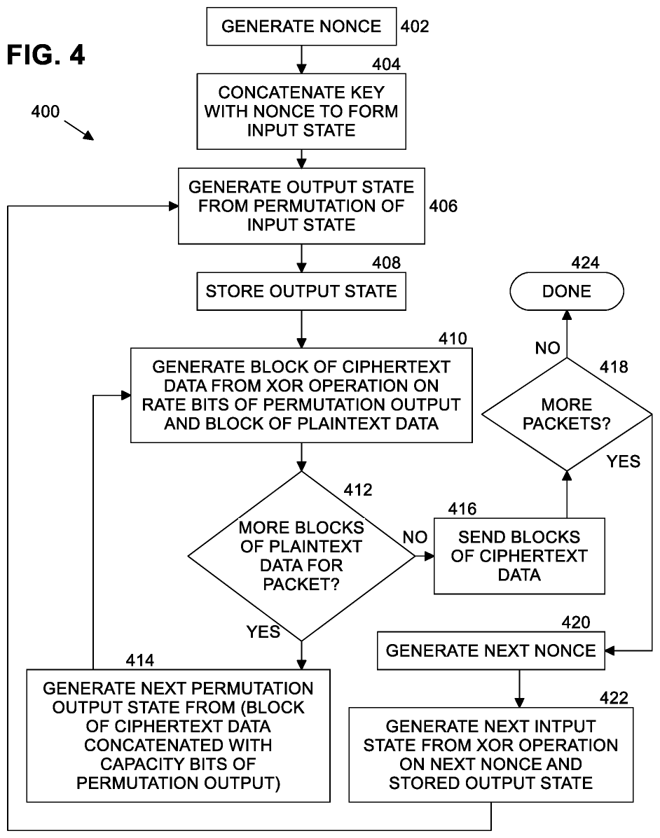

FIG. 4 is a flow diagram illustrating encryption processing 400 according to one or more embodiments. A secure data transfer operation may be started between Alice and Bob assuming that there is a shared secret session key 202 and deterministic nonce generation mechanism in sync between Alice (e.g., first computing system 102) and Bob (second computing system 142). In one example, Alice acts as a sender of a message, performing encryption of a plurality of packets of a plaintext message to form a ciphertext message, and sending the ciphertext message to Bob. Bob acts as a receiver of the ciphertext message, performing decryption of the ciphertext message to form the plaintext message.

At block 402, first computing system 102 generates nonce 204 (e.g., the first nonce used for processing the first packet of the message). At block 404, first computing system 102 concatenates key 202 with nonce 204 to form input state 203. This is the first input state for encryption processing of the first packet of the message. In various implementations, blocks 402 and 404 may be performed by processor 108, accelerator 120, LWAE 105-1, LWAE 105-2, or other circuitry in first computing system 102. At block 406, a block encryption circuit of a LWAE circuit (e.g., LWAE 105-1 or LWAE 105-2, as shown in FIGS. 2A, 2B, 3A and 3B) generates an output state by performing a permutation operation on the input state using a permutation circuit. For example, for a first block of a first packet of the message, block 406 is performed by block 1 encryption circuit 206-1 using permutation circuit 208-1 on input state 203 to generate output state 210. At block 408, the output state 210 is stored. In various implementations, block 408 may be performed by processor 108, accelerator 120, LWAE 105-1, LWAE 105-2, or other circuitry in first computing system 102. At block 410, the block encryption circuit generates a block of ciphertext data from an XOR operation on rate bits of the output of the permutation circuit and a block of plaintext data. For example, for a first block of a first packet of the message, block 410 is performed by block 1 encryption circuit 206-1 using permutation circuit 208-1 to generate output state 210, rate 207-1 bits, capacity 209-1 bits, and by using XOR 214-1 to generate block 1 ciphertext data 216 from rate 207-1 and block 1 plaintext data 212.

At block 412, if there are more blocks in the current packet to process, then processing continues with block 414. For example, when the first block of the first packet has been processed and there are more blocks for the first packet still to be processed, processing continues with the next block of the first packet. At block 414, the next block encryption circuit generates the next (permutation) output state using a block of ciphertext data concatenated with capacity bits of the (previous) permutation output. For example, for a next block of the first packet, block 414 is performed by block 2 encryption circuit 206-2 using permutation circuit 208-2 to generate rate 207-2 bits and capacity 209-2 bits from the value of block 1 ciphertext data 216 concatenated with capacity 209-1 bits. Processing continues with the next block at block 410. For example, for the second block (that is, the current next block), block 2 encryption circuit 206-2 generates block 2 ciphertext data 226 using rate 207-2 XORed with block 2 plaintext data 222. Blocks 410, 412, and 414 are repeated for each of the M blocks in the first packet. Thus, the M′th block will be processed by block M encryption circuit 206-M of FIG. 2B. For the last (e.g., M′th) block in the first packet, block M encryption circuit 206-M generates block M ciphertext data 336 using rate 207-M XORed with block M plaintext data 232 by XOR 214-M.

At block 412, if there are no more blocks of plaintext data to be processed for the first packet, then at block 416, first computing system 102 (e.g., Alice) sends the blocks of ciphertext data for the first packet to second computing system 142 (e.g., Bob). If there are no more packets of the message to be processed at block 418, then LWAE processing is done for the message at block 424. If there are more packets to be processed for the message, then at block 420, first computing system 102 generates a next nonce 304 for use in processing the next packet. At block 422, first computing system 102 generates next input state 303 by performing XOR operation 302 on the next nonce 304 and the stored output state 210 from the processing of the previous packet. In an implementation, each packet is processed with a different nonce, previous output state, and thus a different input state. In various implementations, blocks 420 and 422 may be performed by processor 108, accelerator 120, LWAE 105-1, LWAE 105-2, or other circuitry in first computing system 102. In the case of processing the first block of the second packet of the message, the output state used is output state 210 as shown in FIG. 2A and FIG. 3A. In the case of processing the first block of a third packet of the message, the output state used is next output state 310 as shown in FIG. 3A. Similarly, the output state of any currently processed packet is used to form the input state for processing of any immediately following packet.

Processing of the next packet continues with block 406 to generate the next output state 310 for the next packet (to be used in processing the packet after the next packet). Processing of all blocks of all packets of the message are similarly handled by iteration through blocks 406 through 424.

When second computing system 142 (e.g., Bob) receives the encrypted message, the second computing system uses LWAE 145-1 or LWAE 145-2 to process the one or more ciphertext blocks of data of the one or more packets of the received, encrypted message to generate one or more plaintext blocks of data of the one or more received packets. The message can then be reassembled from the decrypted plaintext blocks of data. For decryption, block 410 is modified by the receiver (second computing system 142) to generate a block of plaintext data from the XOR operation on the rate bits of the permutation output and a block of ciphertext data.

The technology described herein can be implemented as any or a combination of one or more microchips or integrated circuits interconnected using a parent board, hardwired logic, software stored by a memory device and executed by a microprocessor, firmware, an application specific integrated circuit (ASIC), and/or an FPGA. The term “logic” includes, by way of example, software or hardware and/or combinations of software and hardware.

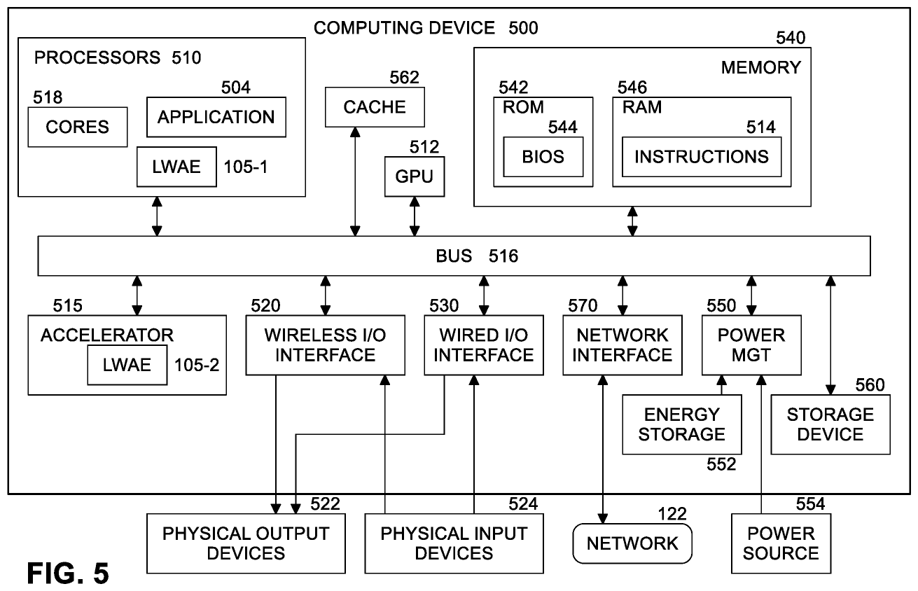

FIG. 5 is a schematic diagram of an illustrative electronic computing device to perform cryptographic processing according to some embodiments. Electronic computing device 500 is representative of computing systems 102 and 142. In some embodiments, computing device 500 includes one or more processors 510 including one or more processors cores 518 and application 504 (e.g., one of application 104 or application 144). In some embodiments, the computing device 500 includes an accelerator 515 (e.g., accelerator 120 or accelerator 170). In some embodiments, the computing device includes LWAE circuitry 105-1 and/or LWAE circuitry 105-2 (or LWAE circuitry 145-1 and/or LWAE circuitry 145-2) to perform encryption and/or decryption processing as described above in FIGS. 2-4.

Computing device 500 may additionally include one or more of the following: cache 562, a graphical processing unit (GPU) 512 (which may be hardware accelerator 120/170 in some implementations), a wireless input/output (I/O) interface 520, a wired I/O interface 530, memory circuitry 540, power management circuitry 550, non-transitory storage device 560, and a network interface 570 for connection to a network 122. The following discussion provides a brief, general description of the components forming the illustrative computing device 500. Example, non-limiting computing devices 500 may include a desktop computing device, blade server device, workstation, laptop computer, mobile phone, tablet computer, personal digital assistant, or similar device or system.

In embodiments, the processor cores 518 are capable of executing machine-readable instruction sets 514, reading data and/or instruction sets 514 from one or more storage devices 560 and writing data to the one or more storage devices 560. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, FPAGs, Internet of Things (IOT) devices, and the like. For example, machine-readable instruction sets 514 may include instructions to implement cryptographic processing, as provided above in FIGS. 1-4.

The processor cores 518 may include any number of hardwired or configurable circuits, some or all of which may include programmable and/or configurable combinations of electronic components, semiconductor devices, and/or logic elements that are disposed partially or wholly in a PC, server, mobile phone, tablet computer, or other computing system capable of executing processor-readable instructions.

The computing device 500 includes a bus or similar communications link 516 that communicably couples and facilitates the exchange of information and/or data between various system components including the processor cores 518, the cache 562, the graphics processor circuitry 512, one or more wireless I/O interfaces 520, one or more wired I/O interfaces 530, one or more storage devices 560, one or more network interfaces 570, and/or accelerator 120/170. The computing device 500 may be referred to in the singular herein, but this is not intended to limit the embodiments to a single computing device 500, since in certain embodiments, there may be more than one computing device 500 that incorporates, includes, or contains any number of communicably coupled, collocated, or remote networked circuits or devices.

The processor cores 518 may include any number, type, or combination of currently available or future developed devices capable of executing machine-readable instruction sets. The processor cores 518 may include (or be coupled to) but are not limited to any current or future developed single-core or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 5 are of conventional design. Consequently, such blocks need not be described in further detail herein, as they will be understood by those skilled in the relevant art. The bus 516 that interconnects at least some of the components of the computing device 500 may employ any currently available or future developed serial or parallel bus structures or architectures.

The system memory 540 may include read-only memory (“ROM”) 542 and random-access memory (“RAM”) 546. A portion of the ROM 542 may be used to store or otherwise retain a basic input/output system (“BIOS”) 544. The BIOS 544 provides basic functionality to the computing device 500, for example by causing the processor cores 518 to load and/or execute one or more machine-readable instruction sets 514. In embodiments, at least some of the one or more machine-readable instruction sets 514 causes at least a portion of the processor cores 518 to provide, create, produce, transition, and/or function as a dedicated, specific, and particular machine, for example a word processing machine, a digital image acquisition machine, a media playing machine, a gaming system, a communications device, a smartphone, a neural network, a machine learning model, or similar devices.

The computing device 500 may include at least one wireless input/output (I/O) interface 520. The at least one wireless I/O interface 520 may be communicably coupled to one or more physical output devices 522 (tactile devices, video displays, audio output devices, hardcopy output devices, etc.). The at least one wireless I/O interface 520 may communicably couple to one or more physical input devices 524 (pointing devices, touchscreens, keyboards, tactile devices, etc.). The at least one wireless I/O interface 520 may include any currently available or future developed wireless I/O interface. Example wireless I/O interfaces include, but are not limited to: BLUETOOTH®, near field communication (NFC), and similar.

The computing device 500 may include one or more wired input/output (I/O) interfaces 530. The at least one wired I/O interface 530 may be communicably coupled to one or more physical output devices 522 (tactile devices, video displays, audio output devices, hardcopy output devices, etc.). The at least one wired I/O interface 530 may be communicably coupled to one or more physical input devices 524 (pointing devices, touchscreens, keyboards, tactile devices, etc.). The wired I/O interface 530 may include any currently available or future developed I/O interface. Example wired I/O interfaces include but are not limited to universal serial bus (USB), IEEE 1394 (“FireWire”), and similar.

The computing device 500 may include one or more communicably coupled, non-transitory, data storage devices 560. The data storage devices 560 may include one or more hard disk drives (HDDs) and/or one or more solid-state storage devices (SSDs). The one or more data storage devices 560 may include any current or future developed storage appliances, network storage devices, and/or systems. Non-limiting examples of such data storage devices 560 may include, but are not limited to, any current or future developed non-transitory machine-readable storage mediums, storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 560 may include one or more removable storage devices, such as one or more flash drives, flash memories, flash storage units, or similar appliances or devices capable of communicable coupling to and decoupling from the computing device 500.

The one or more data storage devices 560 may include interfaces or controllers (not shown) communicatively coupling the respective storage device or system to the bus 516. The one or more data storage devices 560 may store, retain, or otherwise contain machine-readable instruction sets, data structures, program modules, data stores, databases, logical structures, and/or other data useful to the processor cores 518 and/or graphics processor circuitry 512 and/or one or more applications executed on or by the processor cores 518 and/or graphics processor circuitry 512. In some instances, one or more data storage devices 560 may be communicably coupled to the processor cores 518, for example via the bus 516 or via one or more wired communications interfaces 530 (e.g., Universal Serial Bus or USB); one or more wireless communications interfaces 520 (e.g., Bluetooth®, Near Field Communication or NFC); and/or one or more network interfaces 570 (IEEE 802.3 or Ethernet, IEEE 802.11, or Wi-Fi®, etc.).

Processor-readable instruction sets 514 and other programs, applications 104, 144, logic sets, and/or modules may be stored in whole or in part in the system memory 540. Such instruction sets 514 may be transferred, in whole or in part, from the one or more data storage devices 560. The instruction sets 514 may be loaded, stored, or otherwise retained in system memory 540, in whole or in part, during execution by the processor cores 518 and/or graphics processor circuitry 512.

The computing device 500 may include power management circuitry 550 that controls one or more operational aspects of the energy storage device 552. In embodiments, the energy storage device 552 may include one or more primary (i.e., non-rechargeable) or secondary (i.e., rechargeable) batteries or similar energy storage devices. In embodiments, the energy storage device 552 may include one or more supercapacitors or ultracapacitors. In embodiments, the power management circuitry 550 may alter, adjust, or control the flow of energy from an external power source 554 to the energy storage device 552 and/or to the computing device 500. The power source 554 may include, but is not limited to, a solar power system, a commercial electric grid, a portable generator, an external energy storage device, or any combination thereof.

For convenience, the processor cores 518, the graphics processor circuitry 512, the wireless I/O interface 520, the wired I/O interface 530, the storage device 560, accelerator 120/170 and the network interface 570 are illustrated as communicatively coupled to each other via the bus 516, thereby providing connectivity between the above-described components. In alternative embodiments, the above-described components may be communicatively coupled in a different manner than illustrated in FIG. 5. For example, one or more of the above-described components may be directly coupled to other components, or may be coupled to each other, via one or more intermediary components (not shown). In another example, one or more of the above-described components may be integrated into the processor cores 518 and/or the graphics processor circuitry 512. In some embodiments, all or a portion of the bus 516 may be omitted and the components are coupled directly to each other using suitable wired or wireless connections.

A flowchart representative of example hardware logic, non-tangible machine-readable instructions, hardware implemented state machines, and/or any combination thereof for implementing computing device 500 (including processor 510 and/or accelerator 515), for example, is shown in FIG. 4. The machine-readable instructions may be one or more executable programs or portion(s) of an executable program for execution by a computer processor such as the processor 510 shown in the example computing device 500 discussed. The program may be embodied in software stored on a non-transitory computer readable storage medium such as a CD-ROM, a floppy disk, a hard drive, a DVD, a Blu-ray disk, or a memory associated with the processor 510, but the entire program and/or parts thereof could alternatively be executed by a device other than the processor 510 and/or embodied in firmware or dedicated hardware. Further, although the example program is described with reference to the flowchart illustrated in FIG. 4, many other methods of implementing the example computing devices 500 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer system, but require addition of a library (e.g., a dynamic link library (DLL)), a software development kit (SDK), an application programming interface (API), etc., in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example process of FIG. 4 may be implemented using executable instructions (e.g., computer and/or machine-readable instructions) stored on a non-transitory computer and/or machine-readable medium such as a hard disk drive, an SSD, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

References to “an implementation,” “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain examples also relate to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions and coupled to a computer system bus.

The following examples pertain to further embodiments. Example 1 is an apparatus including a block encryption circuit to encrypt a plaintext message, the plaintext message including a plurality of packets, a packet of the plurality of packets including a plurality of blocks, the block encryption circuit including a permutation circuit to iteratively generate output states, rates and capacities, as permutations of input states, as results of operations of the permutation circuit, a first input state of the input states for a first operation of the permutation circuit including a key and a first nonce and a subsequent input state of a plurality of subsequent input states for a subsequent operation of the permutation circuit including an output state of a previous operation of the permutation circuit on a first block of a previous packet of the plaintext message combined with one of a plurality of subsequent nonces for processing of a current packet of the plaintext message by the subsequent operation of the permutation circuit, the rates including first portions of the output states and the capacities including second portions of the output states; and an exclusive-OR (XOR) circuit to iteratively generate blocks of ciphertext data from the rates and blocks of plaintext data of the plurality of packets; and a memory to store the output state of the previous operation of the permutation circuit on the first block of the previous packet of the plaintext message.

In Example 2, the subject matter of Example 1 can optionally include wherein the subsequent input state of the plurality of subsequent input states for the subsequent operation of the permutation circuit includes the output state of the previous operation of the permutation circuit on the first block of the previous packet of the plaintext message XORed with the one of a plurality of subsequent nonces for processing of the current packet of the plaintext message by the subsequent operation of the permutation circuit. In Example 3, the subject matter of Example 1 can optionally include wherein operation of the permutation circuit performs a cryptographic permutation according to an authenticated encryption process.

Example 4 is a method including generating, from a permutation of a first input state, a first output state, a first rate and a first capacity, the first rate including a first portion of the first output state and the first capacity including a second portion of the first output state; storing the first output state; generating a first block of ciphertext data of a first packet from XORing the first rate and a first block of plaintext data of the first packet; determining no more blocks of the first packet are to be processed; and in response to determining at least one more block of the first packet is to be processed, generating a permutation of a value of the first block of ciphertext data of the first packet concatenated with the first capacity, and generating a second block of ciphertext data of the first packet from XOR of the permutation of the value of the first block of ciphertext data of the first packet concatenated with the first capacity.

In Example 5, the subject matter of Example 4 can optionally include wherein the first input state comprises a key concatenated with a first nonce. In Example 6, the subject matter of Example 4 can optionally include generating a second nonce and generating a second input state by XORing the first output state with the second nonce. In Example 7, the subject matter of Example 4 can optionally include generating, from a permutation of the second input state, a second output state, a third rate, and a third capacity, the third rate including a first portion of the second output state and the third capacity including a second portion of the second output state; storing the second output state; and generating a first block of ciphertext data of a second packet from XORing the third rate and a first block of plaintext data of the second packet. In Example 8, the subject matter of Example 7 can optionally include generating, as a permutation of the first block of ciphertext data of the second packet and the third capacity, a fourth rate and a fourth capacity, the fourth rate including a first portion of the permutation of first block of ciphertext data of the second packet and the third capacity and the fourth capacity including a second portion of the permutation of first block of ciphertext data of the second packet and the third capacity; and generating a second block of ciphertext data of the second packet from XORing the fourth rate and a second block of plaintext data of the second packet. In Example 9, the subject matter of Example 4 can optionally include in response to determining that no more blocks of the first packet are to be processed, sending blocks of ciphertext data of the first packet to a receiver.

Example 10 is an apparatus including a block decryption circuit to decrypt a ciphertext message, the ciphertext message including a plurality of packets, a packet of the plurality of packets including a plurality of blocks, the block decryption circuit including a permutation circuit to iteratively generate output states, rates and capacities, as permutations of input states, as results of operations of the permutation circuit, a first input state of the input states for a first operation of the permutation circuit including a key and a first nonce and a subsequent input state of a plurality of subsequent input states for a subsequent operation of the permutation circuit including an output state of a previous operation of the permutation circuit on a first block of a previous packet of the ciphertext message combined with one of a plurality of subsequent nonces for processing of a current packet of a plaintext message by the subsequent operation of the permutation circuit, the rates including first portions of the output states and the capacities including second portions of the output states; and an exclusive-OR (XOR) circuit to iteratively generate blocks of plaintext data from the rates and blocks of ciphertext data of the plurality of packets; and a memory to store the output state of the previous operation of the permutation circuit on the first block of the previous packet of the plaintext message.

In Example 11, the subject matter of Example 10 can optionally include wherein the subsequent input state of the plurality of subsequent input states for the subsequent operation of the permutation circuit includes the output state of the previous operation of the permutation circuit on the first block of the previous packet of the ciphertext message XORed with the one of a plurality of subsequent nonces for processing of the current packet of the ciphertext message by the subsequent operation of the permutation circuit. In Example 12, the subject matter of Example 10 can optionally include wherein operation of the permutation circuit performs a cryptographic permutation according to an authenticated encryption process.

Example 13 is a method including generating, from a permutation of a first input state, a first output state, a first rate and a first capacity, the first rate including a first portion of the first output state and the first capacity including a second portion of the first output state; storing the first output state; generating a first block of plaintext data of a first packet from XORing the first rate and a first block of ciphertext data of the first packet; determining no more blocks of the first packet are to be processed; and in response to determining at least one more block of the first packet is to be processed, generating a permutation of a value of the first block of plaintext data of the first packet concatenated with the first capacity, and generating a second block of plaintext data of the first packet from XOR of the permutation of the value of the first block of plaintext data of the first packet concatenated with the first capacity.

In Example 14, the subject matter of Example 13 can optionally include wherein the first input state comprises a key concatenated with a first nonce. In Example 15, the subject matter of Example 13 can optionally include generating a second nonce and generating a second input state by XORing the first output state with the second nonce. In Example 16, the subject matter of Example 13 can optionally include generating, from a permutation of the second input state, a second output state, a third rate, and a third capacity, the third rate including a first portion of the second output state and the third capacity including a second portion of the second output state; storing the second output state; and generating a first block of plaintext data of a second packet from XORing the third rate and a first block of ciphertext data of the second packet. In Example 17, the subject matter of Example 16 can optionally include generating, as a permutation of the first block of plaintext data of the second packet and the third capacity, a fourth rate and a fourth capacity, the fourth rate including a first portion of the permutation of first block of plaintext data of the second packet and the third capacity and the fourth capacity including a second portion of the permutation of first block of plaintext data of the second packet and the third capacity; and generating a second block of plaintext data of the second packet from XORing the fourth rate and a second block of ciphertext data of the second packet. In Example 18, the subject matter of Example 13 can optionally include in response to determining that no more blocks of the first packet are to be processed, sending blocks of plaintext data of the first packet to a receiver.

Example 19 is an apparatus including a first block encryption circuit including a first permutation circuit to generate, as a permutation of a first input state, a first output state, a first rate and a first capacity, the first rate including a first portion of the first output state and the first capacity including a second portion of the first output state; and a first exclusive-OR (XOR) circuit to generate a first block of ciphertext data of a first packet from the first rate and a first block of plaintext data of the first packet; and a second block encryption circuit including a second permutation circuit to generate, as a permutation of the first block of ciphertext data of the first packet and the first capacity, a second rate and a second capacity, the second rate including a first portion of the permutation of first block of ciphertext data of the first packet and the first capacity and the second capacity including a second portion of the permutation of first block of ciphertext data of the first packet and the first capacity; and a second XOR circuit to generate a second block of ciphertext data of the first packet from the second rate and a second block of plaintext data of the first packet.

In Example 20, the subject matter of Example 19 can optionally include wherein the first input state comprises a key concatenated with a first nonce. In Example 21, the subject matter of Example 19 can optionally include wherein the first permutation circuit and the second permutation circuit perform a cryptographic permutation operation of an authenticated encryption process. In Example 22, the subject matter of Example 19 can optionally include wherein the first block encryption circuit and the second block encryption circuit are a same circuit. In Example 23, the subject matter of Example 19 can optionally include a memory to store the first output state. In Example 24, the subject matter of Example 19 can optionally include a third block encryption circuit including a third permutation circuit to generate, as a permutation of a second input state, a second output state, a third rate, and a third capacity, the third rate including a first portion of the second output state and the third capacity including a second portion of the second output state; and a third exclusive-OR (XOR) circuit to generate a first block of ciphertext data of a second packet from the third rate and a first block of plaintext data of the second packet.

In Example 25, the subject matter of Example 24 can optionally include wherein the second input state comprises the first output state XORed with a second nonce. In Example 26, the subject matter of Example 24 can optionally include wherein the second input state comprises the first output state concatenated with a second nonce. In Example 27, the subject matter of Example 24 can optionally include a fourth block encryption circuit including a fourth permutation circuit to generate, as a permutation of the first block of ciphertext data of the second packet and the third capacity, a fourth rate and a fourth capacity, the fourth rate including a first portion of the permutation of first block of ciphertext data of the second packet and the third capacity and the fourth capacity including a second portion of the permutation of first block of ciphertext data of the second packet and the third capacity; and a second XOR circuit to generate a second block of ciphertext data of the second packet from the fourth rate and a second block of plaintext data of the second packet. In Example 28, the subject matter of Example 27 can optionally include wherein the first block encryption circuit, the second block encryption circuit, the third block encryption circuit and the fourth block encryption circuit are a same circuit.

Example 29 is an apparatus operative to perform the method of any one of Examples 4 to 9 and 13 to 18. Example 30 is an apparatus that includes means for performing the method of any one of Examples 4 to 9 and 13 to 18. Example 31 is an apparatus that includes any combination of modules and/or units and/or logic and/or circuitry and/or means operative to perform the method of any one of Examples 4 to 9 and 13 to 18. Example 32 is an optionally non-transitory and/or tangible machine-readable medium, which optionally stores or otherwise provides instructions that if and/or when executed by a computer system or other machine are operative to cause the machine to perform the method of any one of Examples 4 to 9 and 13 to 18.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a block encryption circuit to encrypt a plaintext message, the plaintext message including a plurality of packets, a packet of the plurality of packets including a plurality of blocks, the block encryption circuit including
a permutation circuit to iteratively generate output states, rates and capacities, as permutations of input states, as results of operations of the permutation circuit, a first input state of the input states for a first operation of the permutation circuit including a key and a first nonce and a subsequent input state of a plurality of subsequent input states for a subsequent operation of the permutation circuit including an output state of a previous operation of the permutation circuit on a first block of a previous packet of the plaintext message combined with one of a plurality of subsequent nonces for processing of a current packet of the plaintext message by the subsequent operation of the permutation circuit, the rates including first portions of the output states and the capacities including second portions of the output states; and
an exclusive-OR (XOR) circuit to iteratively generate blocks of ciphertext data from the rates and blocks of plaintext data of the plurality of packets; and
a memory to store the output state of the previous operation of the permutation circuit on the first block of the previous packet of the plaintext message.

2. The apparatus of claim 1, wherein the subsequent input state of the plurality of subsequent input states for the subsequent operation of the permutation circuit includes the output state of the previous operation of the permutation circuit on the first block of the previous packet of the plaintext message XORed with the one of a plurality of subsequent nonces for processing of the current packet of the plaintext message by the subsequent operation of the permutation circuit.

3. The apparatus of claim 1, wherein operation of the permutation circuit performs a cryptographic permutation according to an authenticated encryption process.

4. A method comprising:
generating, from a permutation of a first input state, a first output state, a first rate and a first capacity, the first rate including a first portion of the first output state and the first capacity including a second portion of the first output state;
storing the first output state;
generating a first block of ciphertext data of a first packet from XORing the first rate and a first block of plaintext data of the first packet;
determining no more blocks of the first packet are to be processed; and
in response to determining at least one more block of the first packet is to be processed, generating a permutation of a value of the first block of ciphertext data of the first packet concatenated with the first capacity, and generating a second block of ciphertext data of the first packet from XOR of the permutation of the value of the first block of ciphertext data of the first packet concatenated with the first capacity.

5. The method of claim 4, wherein the first input state comprises a key concatenated with a first nonce.

6. The method of claim 4, comprising generating a second nonce and generating a second input state by XORing the first output state with the second nonce.

7. The method of claim 4, comprising:
generating, from a permutation of the second input state, a second output state, a third rate, and a third capacity, the third rate including a first portion of the second output state and the third capacity including a second portion of the second output state;
storing the second output state; and
generating a first block of ciphertext data of a second packet from XORing the third rate and a first block of plaintext data of the second packet.

8. The method of claim 7, comprising:
generating, as a permutation of the first block of ciphertext data of the second packet and the third capacity, a fourth rate and a fourth capacity, the fourth rate including a first portion of the permutation of first block of ciphertext data of the second packet and the third capacity and the fourth capacity including a second portion of the permutation of first block of ciphertext data of the second packet and the third capacity; and
generating a second block of ciphertext data of the second packet from XORing the fourth rate and a second block of plaintext data of the second packet.

9. The method of claim 4, comprising:
in response to determining that no more blocks of the first packet are to be processed, sending blocks of ciphertext data of the first packet to a receiver.

10. At least one least one machine-readable storage medium comprising instructions which, when executed by at least one processor, cause the at least one processor to:
generate, from a permutation of a first input state, a first output state, a first rate and a first capacity, the first rate including a first portion of the first output state and the first capacity including a second portion of the first output state;
store the first output state;
generate a first block of ciphertext data of a first packet from XORing the first rate and a first block of plaintext data of the first packet;
determine no more blocks of the first packet are to be processed; and
in response to determining at least one more block of the first packet is to be processed, generate a permutation of a value of the first block of ciphertext data of the first packet concatenated with the first capacity, and generate a second block of ciphertext data of the first packet from XOR of the permutation of the value of the first block of ciphertext data of the first packet concatenated with the first capacity.

11. The at least one least one machine-readable storage medium of claim 10, wherein the first input state comprises a key concatenated with a first nonce.

12. The at least one least one machine-readable storage medium of claim 10, comprising instructions, which when executed by the at least one processor, cause the at least one processor to generate a second nonce and generating a second input state by XORing the first output state with the second nonce.

13. The at least one least one machine-readable storage medium of claim 10, comprising instructions, which when executed by the at least one processor, cause the at least one processor to:
generate, from a permutation of the second input state, a second output state, a third rate, and a third capacity, the third rate including a first portion of the second output state and the third capacity including a second portion of the second output state;
store the second output state; and
generate a first block of ciphertext data of a second packet from XORing the third rate and a first block of plaintext data of the second packet.

14. The at least one least one machine-readable storage medium of claim 13, comprising instructions, which when executed by the at least one processor, cause the at least one processor to:
generate, as a permutation of the first block of ciphertext data of the second packet and the third capacity, a fourth rate and a fourth capacity, the fourth rate including a first portion of the permutation of first block of ciphertext data of the second packet and the third capacity and the fourth capacity including a second portion of the permutation of first block of ciphertext data of the second packet and the third capacity; and
generate a second block of ciphertext data of the second packet from XORing the fourth rate and a second block of plaintext data of the second packet.

15. The at least one least one machine-readable storage medium of claim 10, comprising instructions, which when executed by the at least one processor, cause the at least one processor to:
in response to determining that no more blocks of the first packet are to be processed, send blocks of ciphertext data of the first packet to a receiver.
